(19) United States
(12) Patent Application Publication
(10) Pub. No.: US 2003/0055874 A1
(43) Pub. Date: Mar. 20, 2003

(54) System for automatically recognizing devices connected in a distributed processing environment

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/940,200

(22) Filed: Aug. 27, 2001

(51) Int. Cl. G06F 15/16; G06F 15/173; G06F 17/00

(52) U.S. Cl. 709/203; 709/245; 707/104.1

(57) ABSTRACT

A system for recognizing devices connected in a distributed processing environment is disclosed. The system includes a client computer including a browser coupled to a network, a server computer coupled to the network, and a database coupled to the network, the database containing information that identifies devices coupled to the network. The client computer browses to a predefined web page and discovers from the database the presence of devices coupled to the network.

### BACKGROUND OF THE INVENTION

1. Field of the Invention

The invention relates generally to processing data in a distributed environment, and, more particularly, to a system for automatically recognizing devices connected in a distributed processing environment.

2. Related Art

The future of information processing and information sharing over a network promises to open vast and unexpected processing ability. For example, processing systems currently under development promise to allow new and heretofore unprecedented sharing of information over a wide area network (WAN) or a local area network (LAN). Such sharing of information includes the ability to exchange generic information for the ultimate purpose of using the generic information to access and develop a set of user specific information. Such information sharing and generation may include, for example, the ability to customize a user's experience when browsing the World Wide Web (WWW), or “web” portion of the Internet. The term “browsing” refers to directing a user's computer to a particular location on the web and displaying a page associated with that location. These locations are identified by a universal resource locator (URL), which acts as an address for such location. Each web page and device connected to the web can be located and accessed by its unique URL. Such a system of using generic access instructions is disclosed in commonly assigned, co-pending U.S. patent application Ser. No. ______, titled “SYSTEM AND METHOD FOR PROCESSING DATA IN A DISTRIBUTED ENVIRONMENT,” filed on ______, and hereby incorporated into this document by reference.

One of the benefits of such a distributed processing environment is the ability to allow a user of a computer to have a customized web browsing experience, regardless of the URL that is visited. Such a system uses the above mentioned generic access instructions to access user specific data that is either located on the user's computer or located remotely from the user's computer. In this manner, the users browsing experience can be consistent regardless of the web site visited. Included in this user's experience is a user's “home service.” The users home service, also referred to herein as a user's “web based imaging home service,” can be any URL that the user chooses.

Furthermore, such a distributed processing environment includes not only web sites having web pages to view, but also includes many interconnected devices, such as computers, printers, facsimile machines, etc. When such devices are interconnected in a common network, it would be desirable for a user that browses to their home service to have access to any of the interconnected devices.

Therefore, there is a need in a distributed processing environment for a system for allowing a user to learn of the availability of and have access to many devices that are connected to a network.

### SUMMARY

A system for recognizing devices connected in a distributed processing environment is disclosed. The system includes a client computer including a browser coupled to a network, a server computer coupled to the network, and a database coupled to the network, the database containing information that identifies devices coupled to the network. The client computer browses to a predefined web page and discovers from the database the presence of devices coupled to the network.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating the overall system environment in which the system for recognizing devices connected in a distributed processing environment resides.

FIG. 2 is a block diagram illustrating an exemplar client computer of FIG. 1.

FIG. 3 is a block diagram illustrating an exemplar environment in which embodiments of the invention reside.

FIGS. 4A and 4B are flowcharts collectively illustrating the operation of particular embodiments of the invention.

### DETAILED DESCRIPTION OF THE INVENTION

The system for recognizing devices connected in a distributed processing environment can be implemented in software (e.g., firmware), hardware, or a combination thereof. In one embodiment, the system for recognizing devices connected in a distributed processing environment is implemented in a configuration in which a plurality of devices are coupled to a network and the user of the system uses a computer, such as a personal computer (PC) to access the connected devices, and in which the invention is implemented using primarily software. Regardless of the manner of implementation, the software portion of the invention can be executed by a special or general-purpose computer, such as a personal computer (PC; IBM-compatible, Apple-compatible, or otherwise), workstation, minicomputer, or mainframe computer.

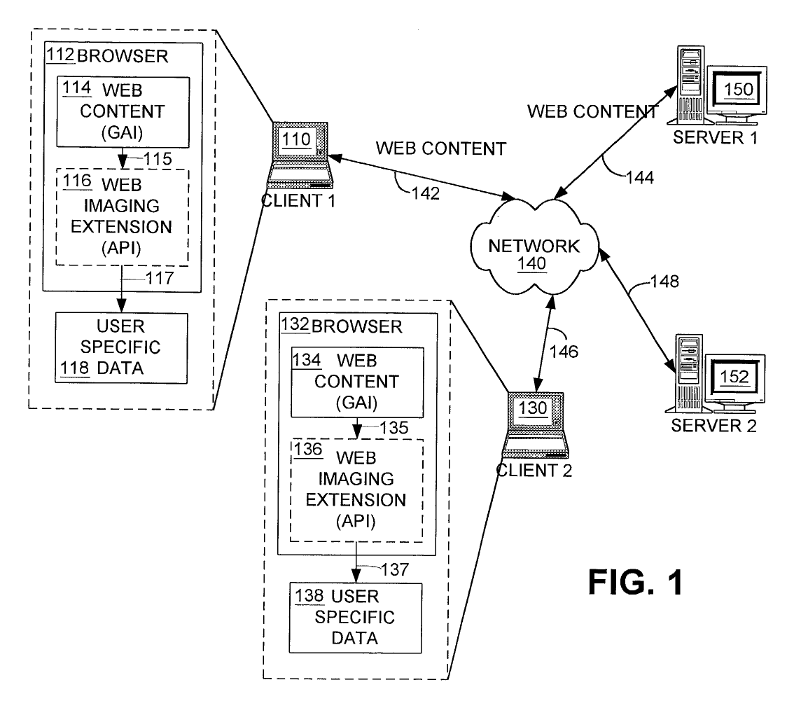

Prior to discussing particular aspects of embodiments of the invention, a brief description of the overall system and environment in which the invention resides is provided. In this regard, FIG. 1 is a block diagram illustrating the overall system environment in which the system for recognizing devices connected in a distributed processing environment resides. FIG. 1 illustrates a client-server environment including a first client computer 110 and a second client computer 130 coupled to a network 140. A first server 150 and a second server 152 are also coupled to the network 140. The first client computer 110 is coupled to the network 140 via connection 142 and the second client computer 130 is coupled to the network 140 via connection 146. Similarly, the first server 150 is coupled to the network 140 via connection 144 and the second server 152 is coupled to the network 140 via connection 148.

The network 140 can be any network used to couple devices and can be, for example, a LAN or a WAN. In the example to follow, the network 140 is illustratively a wide area network such as the WWW portion of the Internet. Furthermore, the connections 142, 144, 146 and 148 can be any known connections that can couple computers to the Internet. For example, the connections 142 and 146 may be dial-up modem style connections, digital subscriber line (DSL) connections, wireless connections, or cable modem connections. The connections 144 and 148 can be high speed access lines, such as T1 or other high speed backbone communication lines.

The first client computer 110 can be, for example but not limited to, a personal computer (PC), such as a laptop computer as illustrated in FIG. 1. Similarly, the second client computer 130 can be a PC or a laptop. The first client computer 110 includes a web browser 112 (referred to hereafter as a “browser”) which receives, processes and displays web content 114. The browser 112 may also include a web imaging extension 116. The web content 114 refers to information that is received from other computers over the network 140, such as the first server 150 or the second server 152. The web imaging extension 116 is an application program interface (API) that resides on the first client computer 110, the operation of which will be described in greater detail below. The first client computer 110 also includes user specific data 118. The user specific data 118 is coupled to the web imaging extension 116 via connection 117 and includes information that is specific to the user of the first client computer 110.

Similarly, the second client computer 130 includes browser 132, which receives, processes and displays web content 134, and may include a web imaging extension 136. The second client computer 130 also includes its user specific data 138. Because the first client computer 110 is similar in structure and functionality to the second client computer 130, the following description will address only the first client computer 110.

The web content 114 includes code portions that invoke methods that are provided in the web imaging extension 116. These methods allow the web content 114 delivered by either the first server 150 or the second server 152 to use the web imaging extension 116 to access information that is specific to the user and that is identified by the user specific data 118. In this manner, a user specific destination can be retrieved and used as a destination address for the browser 112. By using content included in the web content 114 to invoke the web imaging extension 116 to access information that is specific to the user and that is identified by the user specific data 118, a user of the first client computer 110 or the second client computer 130 can have a personalized web browsing experience.

Essentially, the web content 114 is code that includes, for example, hypertext mark-up language (HTML) commands that generate images, forms, etc., and includes graphics and code such as JAVAScript and Java applets. The web content 114 also includes one or more generic access instructions that are part of the content. The generic access instructions invoke methods provided by the web imaging extension 116 in order to access various information through the user specific data 118. In operation, code portions contained in the web content 114 make function calls to the web imaging extension 116. In accordance with an aspect of particular embodiments of the invention, these function calls will vary depending upon the information identified and accessed through the user specific data 118. Specifically, the user specific data 118 identifies and provides access to different types of information that may be different for each user. The web imaging extension 116 includes a set of methods that the web content 114 can make use of in order to access information that is specific to the user and that is identified by the user specific data 118.

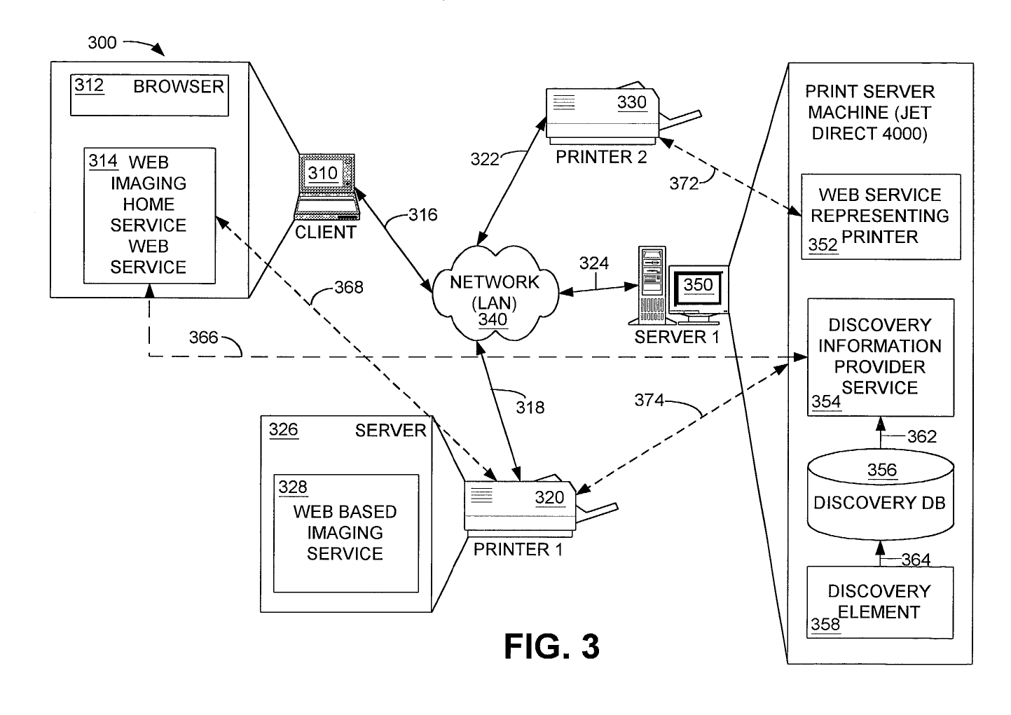

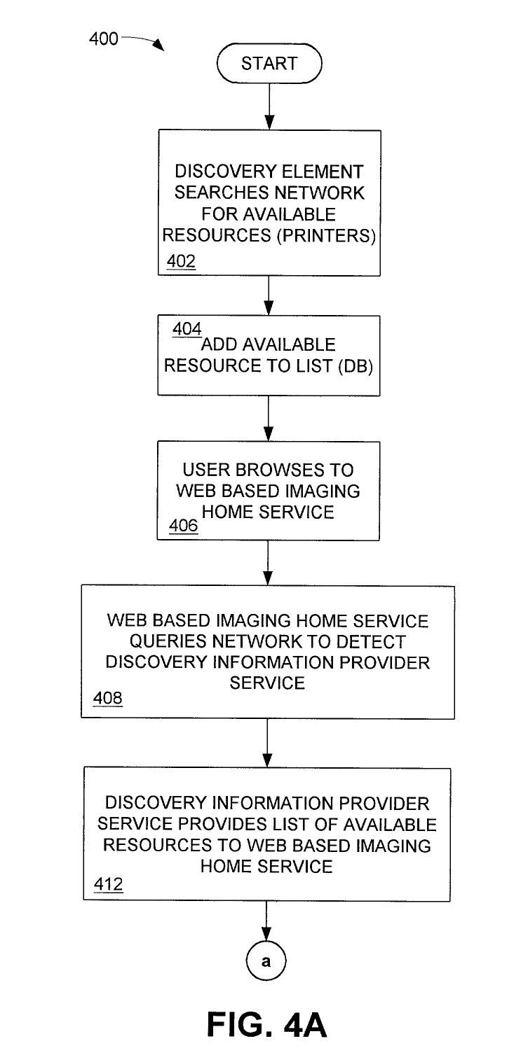

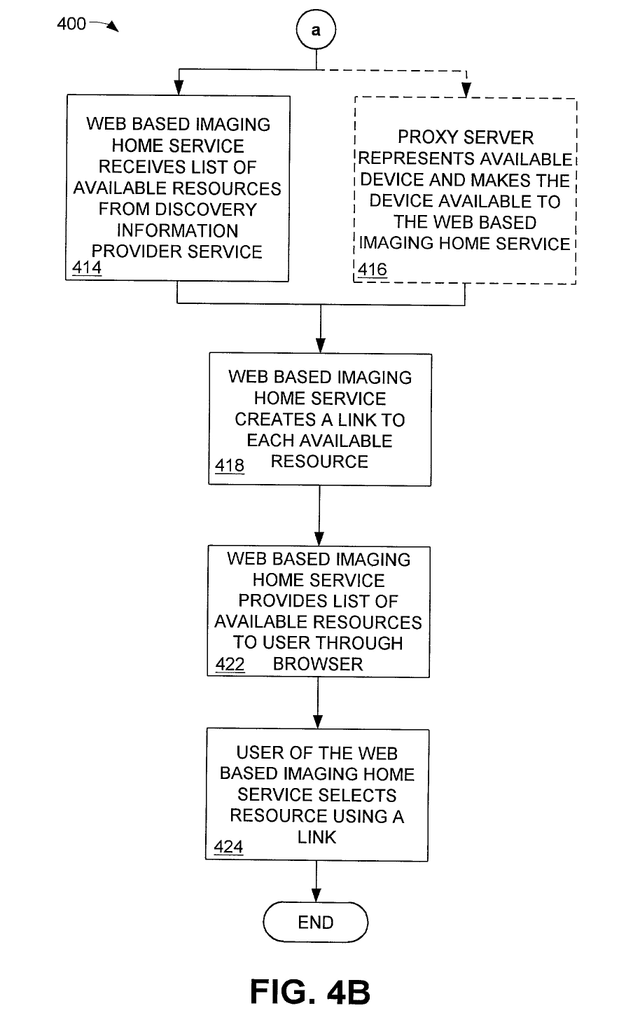

A brief description of the operation of the system shown in FIG. 1 may be helpful in understanding the operation of particular aspects of the invention to be described below with respect to FIGS. 3, 4A and 4B. Assume that an individual using the client computer 110 points the browser 112 to a particular web site located on the first server 150. Such a web site may be the user's “home service.” In such an instance, the browser 112 requests content from the web server 150, which content is delivered to the first client computer 110 and stored as web content 114. As mentioned above, the web content 114 may include code that includes all the information necessary to present a web page to the user of the client computer 110 using the browser 112. Importantly, the content that is sent from the first server 150 to the first client computer 110 also includes one or more generic access instructions. The generic access instructions are a part of the web content 114 and include code that invokes methods provided by the web imaging extension 116 to access information that is identified by the user specific data 118.

Assume that a user desires that a particular home page (home service) that is identified by the user specific data 118 be presented to the user of the first client computer 110. Such a home service might be, for example, a web imaging home page stored on the second server 152. For example, the users browser 112 may be directed to the user's web imaging home page by being launched or redirected by a printer driver (not shown) located on the client computer 110. Alternatively, the user's web imaging home page may be stored in a directory and accessed as necessary, or may be determined by a registration process.

In this example, the location of the user's home service (the web imaging home page) is the second server 152. In this manner, the browser 112 is redirected to a location that is specific to a particular user. By allowing the user to browse to a user specific destination, the web imaging extension allows a user to browse to “their own” home page from anywhere on the Internet.

The foregoing description addresses a computing environment in which the imaging extension 116 is used to make user information available to the web content 114 downloaded into the browser 112. The imaging extension 116 makes information associated with the user's identity available. The primary purpose of the imaging extension 116 is to provide access to information that is identified by the user specific data 118. In essence, this is a client-side approach to identifying user information. Alternatively, a server-side approach to identifying user information is possible. This can be accomplished by moving the logic normally present in the web content 114 running within the browser 112 into the web server 150. Rather than the web content 114 accessing the services specific to the user, the web server accesses the services specific to the user. In other words, the identity technology is server side instead of client side.

When using server side identity technology, and because the browser 112 no longer provides information regarding the user's identity, an “authentication website” can be used to provide such information. In such an arrangement, the web imaging home page redirects the browser 112 to the authentication website. The authentication website determines the identity of the user and then redirects the browser 112 back to the web imaging home page with the user identity, including the location of the user's profile. In this scheme, it is assumed that all “web imaging home pages,” or more generally, all imaging destinations, have information regarding the authentication server. Once the user's identity is determined (i.e. the location of the user's profile is know) the web imaging home page can directly interact with services specific to the user without the aid of the imaging extension.

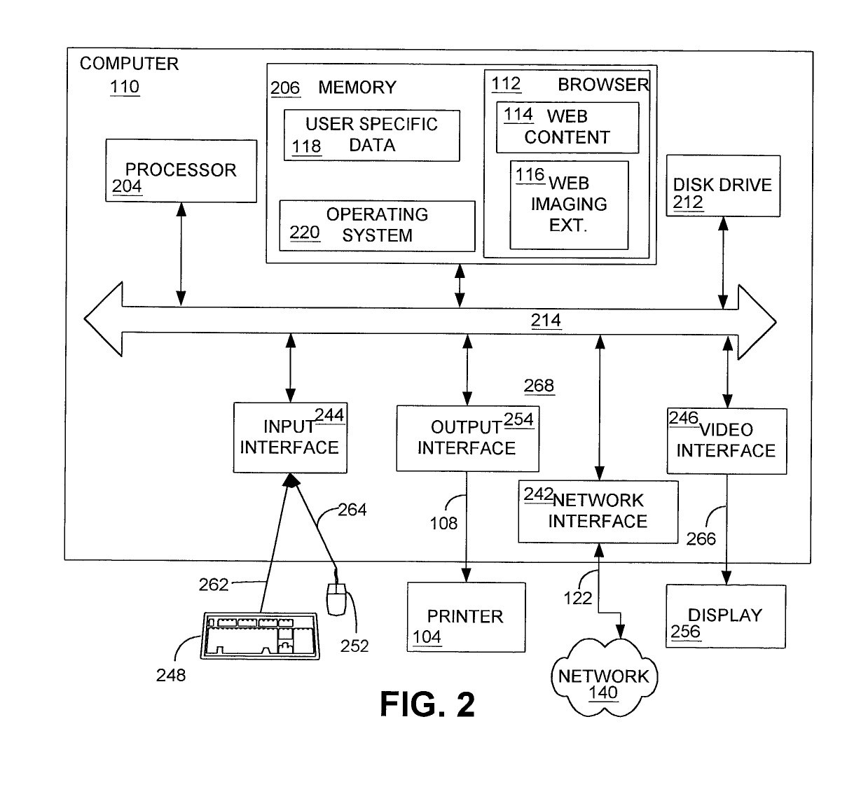

An example of a general-purpose computer that can implement the software of the invention is shown in FIG. 2. FIG. 2 is a block diagram illustrating an exemplar first client computer 110 of FIG. 1. The first client computer 110 can implement the system for recognizing devices connected in a distributed processing environment. The web content 114, web imaging extension 116 and the user specific data 118 and other software and hardware elements (to be discussed with respect to FIG. 2) work in unison to implement the functionality of the invention. Generally, in terms of hardware architecture, as shown in FIG. 2, the first client computer 110 includes a processor 204, memory 206, a disk drive 212, an input interface 244, a video interface 246, an output interface 254 and a network interface 242 that are connected together and can communicate with each other via a local interface 214. The local interface 214 can be, for example but not limited to, one or more buses or other wired or wireless connections, as is known to those having ordinary skill in the art. The local interface 214 may have additional elements, which are omitted for simplicity, such as buffers (caches), drivers, and controllers, to enable communications. Further, the local interface 214 includes address, control, and data connections to enable appropriate communications among the aforementioned components.

The processor 204 is a hardware device for executing software that can be stored in memory 206. The processor 204 can be any custom made or commercially available processor, a central processing unit (CPU) or an auxiliary processor among several processors associated with the computer 202, and a microchip-based microprocessor or a macroprocessor. Examples of suitable commercially available microprocessors are as follows: a PA-RISC series microprocessor from Hewlett-Packard Company, an 80x86 or Pentium series microprocessor from Intel Corporation, a PowerPC microprocessor from IBM Corporation, a Sparc microprocessor from Sun Microsystems, Inc., or a 68xxx series microprocessor from Motorola Corporation.

The memory 206 can include any one or combination of volatile memory elements (e.g., random access memory (RAM, such as DRAM, SRAM, etc.)) and nonvolatile memory elements (e.g., RAM, ROM, hard drive, tape, CDROM, etc.). Moreover, the memory 206 may incorporate electronic, magnetic, optical, and/or other types of storage media. Note that the memory 206 can have a distributed architecture, where various components are situated remote from one another, but can be accessed by the processor 204.

The input interface 244 can receive commands from, for example, keyboard 248 via connection 262 and from mouse 252 via connection 264 and transfer those commands over the local interface 214 to the processor 204 and the memory 206.

The video interface 246 supplies a video output signal via connection 266 to the display 256. The display 256 can be a conventional CRT based display device, or can be any other display device, such as a liquid crystal display (LCD) or other type of display. The output interface 254 sends printer commands via connection 108 to the printer 104. The network interface 242, which can be, for example, a network interface card located in the first client computer 110 or a modulator/demodulator (modem) can be any communication device capable of connecting the first client computer 110 to an external network 140.

The software in memory 206 may include one or more separate programs, each of which comprises an ordered listing of executable instructions for implementing logical functions. In the example of FIG. 2, the software in the memory 206 includes the software required to run the browser 112 and process the web content 114. The memory 206 also includes the web imaging extension 116 and stores the user specific data 118. The memory 206 also includes a suitable operating system (O/S) 220. With respect to the operating system 220, a non-exhaustive list of examples of suitable commercially available operating systems 220 is as follows: a Windows operating system from Microsoft Corporation, a Netware operating system available from Novell, Inc., or a UNIX operating system, which is available for purchase from many vendors, such as Hewlett-Packard Company, Sun Microsystems, Inc., and AT&T Corporation. The operating system 220 essentially controls the execution of other computer programs, such as the browser 112, and provides scheduling, input-output control, file and data management, memory management, and communication control and related services. The processor 204 and operating system 220 define a computer platform, for which application programs, such as the browser 112, in higher level programming languages are written.

If the first client computer 110 is a PC, the software in the memory 206 further includes a basic input output system (BIOS) (omitted for simplicity). The BIOS is a set of essential software routines that test hardware at startup, start the O/S 220, and support the transfer of data among the hardware devices. The BIOS is stored in ROM as that it can be executed when the first client computer 110 is activated.

When the first client computer 110 is in operation, the processor 204 is configured to execute software stored within the memory 206, to communicate data to and from the memory 204 and to generally control operations of the first client computer 110 pursuant to the software. The browser 112, portions of the web content 114, web imaging extension 116 and the O/S 220, in whole or in part, but typically the latter, are read by the processor 204, perhaps buffered within the processor 204, and then executed.

When the system for recognizing devices connected in a distributed processing environment is implemented primarily in software, as is shown in FIG. 2, it should be noted that the browser 112, web content 114 and web imaging extension 116 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The browser 112, web content 114 and web imaging extension 116 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The hardware components of the invention can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 3 is a block diagram illustrating an exemplar processing environment in which embodiments of the invention reside. The processing environment 300 includes a client computer 310 coupled via connection 316 to a network 340. The connection 316 can be a conventional, modem-type wired connection or can be a wireless connection. The network 340 can be a LAN or a WAN, and for illustrative purposes only, is a LAN in this example. Typically, many such client computers will be coupled to the network 340. The processing environment 300 also includes a server 350 coupled to the network 340 via connection 324. The server 350, in this example, is a print server machine such as, for example but not limited to, a Hewlett-Packard Jet Direct 4000. A first printer 320 is coupled to the network 340 via connection 318 and a second printer 330 is coupled to the network 340 via connection 322. In this example, the first printer 320 is a “web enabled” printer, and therefore includes a server 326 and a web based imaging service 328. The web based imaging service 328 allows the first printer 320 to advertise its capabilities over the network 340. The second printer 330 is a conventional printer (i.e., it is not “web enabled”) and is referred to as a “legacy printer.”

The client computer 310 includes a browser 312 and a web based imaging home service (“home service”) 314. The home service 314 can be, for example, a server running on the client computer 310, and is a location to which a user of the client computer 310 can always browse using browser 312.

The server 350 includes a discovery element 358 coupled to a discovery database 356 via connection 364. The discovery database 356 is coupled via connection 362 to a discovery information provider service 354. The discovery element 358 is a software component that can discover the presence of all types of devices coupled to the network 340. For example, the discovery element 358 can query all devices on the network by performing simple network management protocol (SNMP) queries for IP addresses in order to discover, for example, but not limited to, first printer 320 and second printer 330. When the discovery element 358 discovers the devices connected to the network 340, it places those devices in the discovery database 356. This is accomplished by building a database containing the URL's of each of the discovered devices. The discovery database 356 while shown as residing within the server 350 may be remotely located from the server 350 and accessible via the network 340.

Essentially, the discovery information provider service 354 is a set of URL's that refer to any discovered device that includes a web server, such as first printer 320. Because the second printer 330 is not a web-enabled device, when the discovery element 358 locates the second printer 330, the discovery element 358 recognizes that the second printer 330 is not web-enabled, and therefore, creates a web service 352 that represents the second printer 330.

One example of creating the web service 352 that represents the second printer 330 is as follows. Imagine that there are a number of executable files (.exe's) located on the server 350 and that each one of these executable files corresponds to a different printer model. These executable files accept the IP address of a printer, such as the second printer 330. When the IP address of the second printer 330 is discovered by the discovery element 358, the discovery element 358 starts an executable file corresponding to the second printer 330 (recall that the second printer 330 does not have its own web server).

The discovery element 358 supplies the IP address of the second printer 330 to the executable file. This running executable file subsequently acts as the web service 352 representing the second printer 330. It should be noted that there are alternative ways of doing this. For example, rather than having a separate executable file for each legacy printer, a common executable file can be used for several legacy printer models and configuration information distinguishing the legacy printer model in question can be supplied to the executable file when it is run. This configuration information could be, for example, a string identifying the legacy printer model or could be the name of a file containing details describing the legacy printer. Furthermore, it is possible for a single executable file to represent a number of different web services. Such a web service 352 representing the printer is included in the printer server 350 as web service 352.

The web service 352 is sometimes referred to as a “proxy server” Because it is acting as a proxy for the second printer 330. Such a proxy server should not be confused with a proxy web server that is sometimes used to provide access through a firewall, as is known by those having ordinary skill in the art. The web service 352 that represents the printer 330 is a server that is capable of participating in the web based imaging system as disclosed in the processing environment 300.

Because the client computer 310 may independently browse to and communicate with any element connected to the network that includes a server, the browser 312 is shown, for example, as connected via dotted line 368 to the first printer 320. This illustrates that the browser 312 located in the client computer 310 can be pointed directly to the web based imaging service 328 located in the first printer 320. However, the physical connection occurs through the network 340. Further, the dotted lines 372 and 374 are used to illustrate that the second printer 330 is coupled to the web service 352, and that the first printer 320 is coupled directly to the printer server 350, respectively, although such connection physically occurs via the network 340. Further, dotted line 366 between the home service 314 and the discovery information provider service 354 is used to illustrate the connectivity that occurs between the client computer 310 and the print server 350 via the network 340.

FIGS. 4A and 4B are flowcharts collectively illustrating the operation of particular embodiments of the invention. In block 402, the discovery element 358 queries the network 340 for available resources, such as first printer 320 and second printer 330 (FIG. 3). In block 404, any discovered resources (i.e., first printer 320 and second printer 330) are added to the discovery database 356. When the second printer 330 is discovered, the discovery element 358 creates the web service 352 that represents the printer 330.

In block 406, a user of the client computer 310 points their browser 312 to their home service 314. In block 408, the home service 314 queries the network to detect the presence of a discovery information provider service 354. This may be accomplished by, for example, the home service 314 using the service location protocol (SLP) to broadcast a packet over the network 340 asking for a particular type of service, in this example a discovery database service such as that provided by the discovery information provider service 354. If there is a discovery information provider service 354 available, it will respond with its identity. The operation of SLP is known to those having ordinary skill in the art. This query occurs over the network 340, but in FIG. 3, is illustrated using dotted line 366. In block 412, the discovery information provider service 354 provides a list of available resources to the home service 314. The list of available resources is essentially a set of URL's that are obtained by the discovery information provider service 354 from the discovery database 356.

In block 414, the home service 314 receives the list of available resources from the discovery information provider service 354. If, in block 402, the discovery element 458 discovers a legacy printer, such as second printer 330, the discovery element 358 will create a web service 352 that represents the printer 330. In block 416, this proxy server, (the web service 352) represents the second printer 330 and makes the second printer 330 available to the home service 314 via the discovery information provider service 354.

In block 418, the home service 314, using the information provided from the discovery information provider service 354, creates a link to each available resource and makes this link available to the user of the client computer 310 as part of the web content that it generates. In this example, the first printer 320 and second printer 330 are available to a user of the client computer 310. Accordingly, the home service 314 will create a link to each printer and make that link available to the user of the computer 310 as, for example, a hyperlink. In block 422, the home service 314 provides a list of these available resources to a user through the browser 312. In block 424, a user of the client computer 310 uses the home service 314 to select a resource using the created links. In this manner, the user of the client computer 310 can have access to any device connected to the network 340. The browser 312 can be redirected to any of these links in a number of ways by using both web content and the home service 314.

It will be apparent to those skilled in the art that many modifications and variations may be made to the preferred embodiments of the present invention, as set forth above, without departing substantially from the principles of the present invention. For example, the system can be used to access any web enabled or non web enabled device that is represented by a web service. All such modifications and variations are intended to be included herein within the scope of the present invention, as defined in the claims that follow.

What is claimed is:

1. A system for recognizing devices connected in a distributed processing environment, comprising:
a client computer coupled to a network and including a browser;
a server computer coupled to the network;
a database coupled to the network and containing information that identifies devices coupled to the network; and
where the client computer browses to a predefined web page and discovers from the database the presence of devices coupled to the network.

2. The system of claim 1, wherein a device coupled to the network includes a web service.

3. The system of claim 1, wherein a device coupled to the network is represented by a web service.

4. The system of claim 1, wherein the client computer receives a uniform resource locator (URL) corresponding to each device coupled to the network.

5. The system of claim 2, wherein the client computer may access directly a device that contains a web service.

6. The system of claim 3, wherein the client computer may access indirectly a device that is represented by a web service.

7. The system of claim 1, wherein URL information identifying each device coupled to the network is maintained in the database and provided to the client computer.

8. A method for recognizing devices connected in a distributed processing environment, comprising:
coupling a client computer to a network, the client computer including a browser;
coupling a server computer to the network;
coupling to the network a database containing information that identifies devices coupled to the network; and
where the client computer browses to a predefined web page and discovers from the database the presence of devices coupled to the network.

9. The method of claim 8, wherein a device coupled to the network includes a web service.

10. The method of claim 8, wherein a device coupled to the network is represented by a web service.

11. The method of claim 8, wherein the client computer receives a uniform resource locator (URL) corresponding to each device coupled to the network.

12. The method of claim 9, wherein the client computer may access directly a device that contains a web service.

13. The method of claim 10, wherein the client computer may access indirectly a device that is represented by a web service.

14. The method of claim 8, wherein URL information identifying each device coupled to the network is maintained in the database and provided to the client computer.

15. A computer readable medium having a program for recognizing devices connected in a distributed processing environment, comprising logic for:
coupling a client computer to a network, the client computer including a browser;
coupling a server computer to the network;
coupling to the network a database containing information that identifies devices coupled to the network; and
where the client computer browses to a predefined web page and discovers from the database the presence of devices coupled to the network.

16. The program of claim 15, wherein a device coupled to the network includes a web service.

17. The program of claim 15, wherein a device coupled to the network is represented by a web service.

18. The program of claim 15, wherein the client computer receives a uniform resource locator (URL) corresponding to each device coupled to the network.

19. The program of claim 16, wherein the client computer may access directly a device that contains a web service.

20. The program of claim 17, wherein the client computer may access indirectly a device that is represented by a web service.

21. The program of claim 15, wherein URL information identifying each device coupled to the network is maintained in the database and provided to the client computer.
